(19) United States
(12) Patent Application Publication
(10) Pub. No.: US 2015/0111171 A1
(43) Pub. Date: Apr. 23, 2015

(54) Coping and crown holder

(71) Applicant: Steven Peterson, Clearwater, FL (US)

(72) Inventor: Steven Peterson, Clearwater, FL (US)

(21) Appl. No.: 13/998,317

(22) Filed: Oct. 21, 2013

(51) Int. Cl. A61C 13/12

(52) U.S. Cl. CPC A61C 13/12
USPC 433/159

(57) ABSTRACT

The Coping and Crown Holder Instrument uses two separate tips at a 35 and 50 degree angle to better hold a coping or crown in place with very little surface contact while applying the proper medium to the coping or crown, while using a 35 degree angle to hold the crown holder up from the surface for easier pick up off a flat surface and easier placement of restorations onto a sagger tray, with 10 degree angles of bend for the finger holes to be closer together for use with the clasp and the stopper.

### BACKGROUND OF THE INVENTION

(1) Field of the Invention

The Coping and Crown Holder is a new design with a very functional use compared to other hemostats existing for dental laboratory use. This is an improvement over existing hemostats.

(2) Description of the Art Including Information Disclosed Under 37 CFR 1.97 & 1.98

The art described in the drawings of the design and utility function illustrate the unique ability of the Coping and Crown holder to hold a crown in place for working on the restoration in a laboratory setting.

### BRIEF SUMMARY OF THE INVENTION

The Coping and Crown Holder uses uniquely designed tips that have different angles of degree for a superior grasp of the coping or crown. This allows for the proper medium to be evenly distributed over the coping or crown without having a spot not covered by the process. The invention is also designed with other angles that allow for easier and superior use.

### BRIEF DESCRIPTION OF THE SEVERAL VIEWS OF THE DRAWINGS

There are 4 drawings in total that describe and illustrate the design and function of the Coping and Crown Holder.

FIG. 1: is the top view of the entire invention.

FIG. 2: is the side view of the invention.

FIG. 3: is the top angle view of the clasp and stopper.

FIG. 4: is the top angle view of the tips to grasp the crown using two different angles.

### DETAILED DESCRIPTION OF THE PREFFERED EMBODIMENT

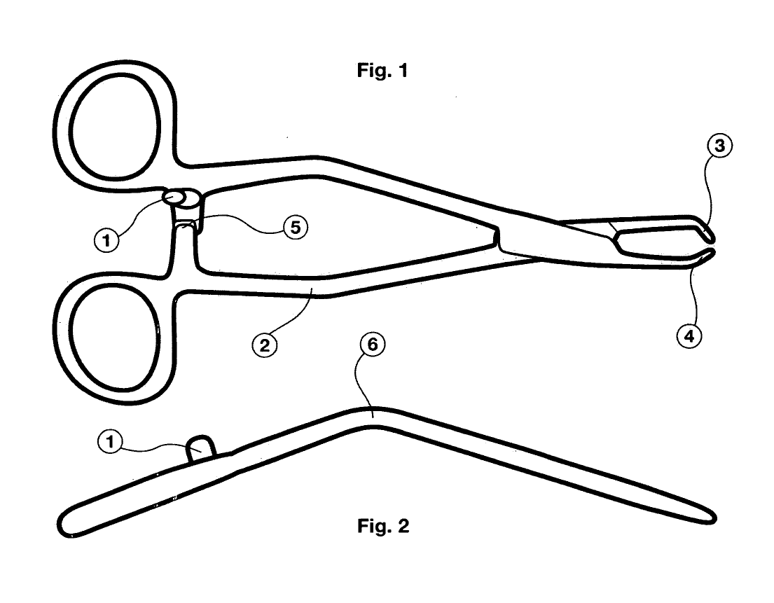

FIG. 1: This illustration shows the top view of the invention with #1 the stopper which prevents the clasp from being pulled too tight as to damage the crown it is holding with #2 shows the 10 degree angle the body shaft is bent inward towards the center to allow the finger holes being close together with #5 the clasp in a closed position with #3 the left side tip with the at the 50 degree angle curve with #4 the right side tip with the 35 degree angle curve.

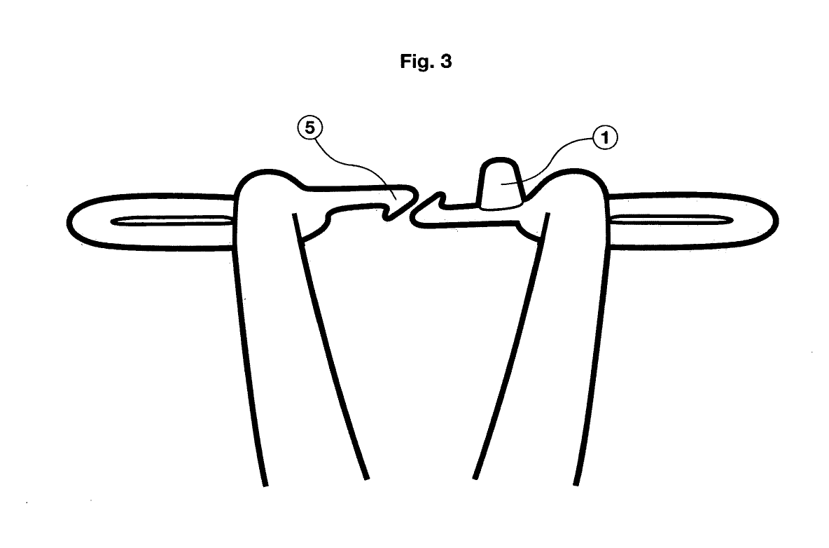

FIG. 2: This illustration shows the #1 stopper with the #6 the 35 degree angle of the upward vertical bend that holds the instrument up off a flat surface for easy pick up and placing restorations on a sagger tray much easier.

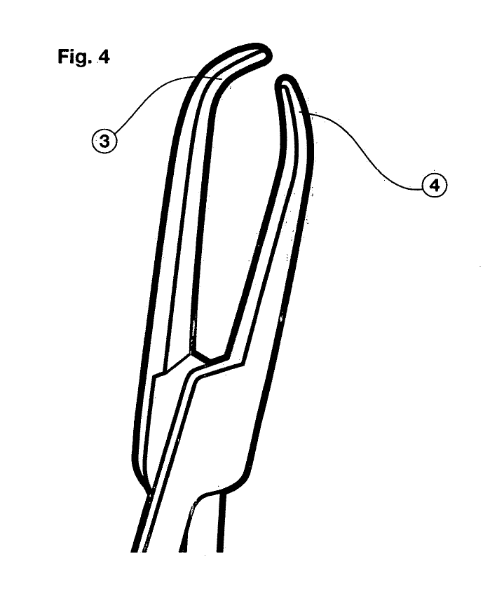

FIG. 3: This illustration shows the #1 stopper with the #5 clasp which the stopper prevents the clasp from being closed any further than the stopper will allow and not allow damage to the crown being held.

FIG. 4: This illustration shows the #3 left side tip at the 50 degree angle curve for holding the crown on the outside of the crown surface with #4 the right aide tip with a 35 degree angle curve to grasp the crown on the inside of the crown being held.

### DETAILED DESCRIPTION OF THE INVENTION

The Coping & Crown Holding Instrument

The unique design of this “Coping and Crown Holder” will greatly help the dental laboratory industry. This instrument will solve several problems, save valuable time and cut labor costs.

A coping or bridge framework is the substructure to which porcelain will be built on to making a laboratory created dental restoration. An instrument “The Coping & Crown Holder” allows the coping or framework to be held during certain laboratory procedures.

Procedures for “Coping & Crown Holder”
Opaquing metal copings and framework
Core staining porcelain copings and framework
Staining and glazing the completed porcelain build-up

Definitions
Opaquing—Opaque is applied to metal copings and bridge framework to cover up the metal, and give it a tooth colored shade.
Core Staining—Core stain is applied to all porcelain copings which covers-up the white color of the coping to accomplish a tooth colored shade.
Staining and Glazing—Glaze and stain is the last procedure done by the technician to customize the shade of the crown which makes it shiny and smooth like natural dentition.

Pros and Cons

Current crown holders do not always work, as they tend to spread out inside the coping to which they are holding. They will not work on shallow copings, as the coping will fly off the holders as they lose the grip. They also cannot be used on veneers, because they are flat in design, and the current hemostats can break them due to them being flat and very thin. Veneers or laminates are restorations where only the facial surface of a tooth is created which makes them flat. With this new design of holder there is no longer a problem with holding these dental restorations as they have pin point gripping.

Regular hemostats can be tightened too much, which bends the margins on metal copings or framework (the margin is the part of the restoration, which will seal against the real tooth when a crown or bridge is seated in the patient's mouth.)

Regular hemostats can also chip or crack the margins on all porcelain copings, crowns or bridges, due to the flat gripping area design. This is no longer the case with the new design “Coping & Crown Holder” as they now have pin point gripping, which does not stress flat or curved surfaces.

Crown holders that hold the crowns from the inside or regular hemostats also allow the crowns or framework to fly out of the grip, which turns into lost, damaged or redoing the work that was already completed.

When holding a coping or framework, applying opaque, core staining, glaze and stain needs to have full coverage, when using regular hemostats a good portion of the coping/framework is covered up by the tips, but with the new design there are pin point gripping points so only a small pin point area is left uncovered, which is ideal when holding a restoration (saves time later on touching up the pin point area versus a large area around the hemostats gripping point.) The pin point gripping creates better holding so the restoration does not fly across the lab having to waste time searching for it (which occurs often with now available crown holders, once again saves time and money.)

The curved tips of “The Coping & Crown Holders” unique design avoids any margin contact in turn avoids bending of metal margins, chipping and cracking of the all porcelain restorations. One side is curved less than the other. The less curved side of the “Coping & Crown Holder” goes inside the restoration and the more drastic curved tip goes to the outside of restoration, which allows for a small paint brush or medium applying instrument to go 360 degrees around the pin point contact area, resulting in almost full coverage of medium being applied (saves time later, as mentioned above remaining pin point versus larger surface area.

Regular hemostats have several (usually three clamping down catches, which allows for too much pressure in turn bending metal margins or cracking all porcelain restorations.)

“The Coping & Crown Holder” has only one clamping catch at reduced pressure so not to cause damage to the restoration. A stopper is also used to prevent the clasp from being closed any further to prevent damage as well.

Copings and framework, metal and all porcelain must be sandblasted prior to applying opaque and, core staining. Sandblasting will remove any contaminants from the surface of the copings and frameworks. The new design of “Coping and Crown Holder” is very ideal for this, also because of the pinpoint contact areas.

Laboratory Technicians usually have many needed instruments on the work area in which they sit, having angled handles assists them in easily identifying and pick up of “The Coping & Crown Holder” very important when very busy.

1. The crown holder using two different tips comprised of:

2. As to claim 1 the left side tip with a shaft beginning from the riveted section with a diameter of 4 mm down to the tip of 0.5 mm diameter with a 50 degree sharp angle inward to the middle for the outside of the crown.

3. As to claim 1 the right side tip with a shaft beginning from the riveted section with a diameter of 4 mm down to the tip of 0.5 mm with a 35 degree soft curved angle inward to the middle for the inside of the crown.

4. (canceled)

5. (canceled)

6. (canceled)

7. (canceled)

8. As to claim 7 a single notched clasp 7 mm in width on both sides with a stopper of 7 mm wide to stop the clasp from tightening too far to prevent the tips from damaging the crown being held.
